(19) United States
(12) Patent Application Publication
(10) Pub. No.: US 2009/0297818 A1
(43) Pub. Date: Dec. 3, 2009

(54) Primer compositions and methods of making the same

(75) Inventors: Dale Williams, Puyallup, WA (US); Ali Raza, Seattle, WA (US)

Correspondence Address: JELD-WEN, Inc. - Stoel Rives LLP, 900 SW Fifth Avenue, Suite 2600, Portland, OR, 97204-1268, US

(73) Assignee: JELD-WEN, inc., Klamath Falls, OR (US)

(21) Appl. No.: 12/154,995

(22) Filed: May 29, 2008

(51) Int. Cl. B32B 21/02; B29C 70/12; C09D 4/02; C09D 131/06; C09D 131/02; C09D 5/00

(52) U.S. Cl. 428/292.4; 264/120; 428/297.4; 524/556; 524/559; 524/560; 524/566; 523/122; 524/444; 524/446; 524/456

(57) ABSTRACT

In one aspect, the invention includes an aqueous composition for coating articles including isocyanate resins. The coating composition includes from about 50% to about 100% by weight of at least one thermoplastic acrylic polymer; from about 0.1% to about 20% by weight titanium dioxide; and water. The composition has a basic pH, a solids ratio of from about 58% to about 69% by weight, and is substantially free of quartz pigments.

### BACKGROUND OF THE INVENTION

The present invention relates to coating compositions. More specifically, the present invention relates to coating compositions, methods of making coating compositions, and uses of coating compositions.

A primer is a preparatory coating put on materials before painting or other processing. Priming ensures better adhesion of paint to the surface, increases paint durability, and provides additional protection for the material being painted.

Primers are paint products that allow finishing paint to adhere much better than if it were used alone. For this purpose, primers are specially designed to adhere to surfaces and to form a binding layer that is better prepared to receive paint. Because primers do not need to be engineered to have durable, finished surfaces, they can instead be engineered to have more aggressive filling and binding properties with the material underneath. Sometimes this is achieved with specific chemistry, as in the case of aluminum primer, but more often this is achieved through controlling the primer's physical properties such as porosity, tackiness, and hygroscopy.

In practice, primers are often used when painting many kinds of porous materials, such as concrete and especially wood or composites including such porous materials (see detailed description below). Priming is often considered mandatory if the material is not water resistant and will be exposed to the elements. Priming gypsum board (drywall) is also standard practice with new construction because it seals the wall and aids in preventing mold. Primers can also be used for dirty surfaces that, for some reason, cannot be cleaned, or before painting light colors over existing dark colors.

Thin-layer lignocellulosic composites, such as those used for doorskins, are often primed before final treatment, such as painting. Adhesion of the primer to the doorskins is important to achieve a uniform coating of any paint or other finish, such as a stain, subsequently applied to the composite. If the primer does not properly adhere to the composite, subsequent finishing layers may fade, crack, and/or bubble, leading to an unsightly and undesirable final product.

Traditional primers do not adhere to composites including isocyanate binders. When traditional primers are applied to such composites, the isocyanate binder in the composite interferes with desired adhesion.

### SUMMARY OF THE INVENTION

In one aspect, the invention is an aqueous composition for coating articles including isocyanate resins. The coating composition includes from about 50% to about 100% by weight of at least one thermoplastic acrylic polymer; from about 0.1% to about 20% by weight titanium dioxide; and water. The composition has a basic pH, a solids ratio of from about 58% to about 69% by weight, and is substantially free of quartz pigments.

In another aspect, the invention is a method for making a coating composition for use on articles including isocyanate resins. The method includes forming a first grind phase by grinding water, at least one surfactant, and at least one solvent together; forming a second grind phase by grinding titanium dioxide into the first grind phase; grinding the second grind phase to form a paste having a Hegman of no greater than about 4; and adding the paste to a let-down composition including water, at least one thermoplastic acrylic polymer, and at least one rheological agent while agitating.

In yet another aspect, the invention is a method of producing a thin-layer lignocellulosic composite having increased resistance to moisture-induced shrinking or swelling. The method includes forming a lignocellulosic composite mixture comprising at least one type of lignocellulosic fiber comprising a predetermined moisture content of at least about 4%, at least about 1 wt % of an organic isocyanate resin, at least about 0.1 wt % tackifier, and at least about 0.1 wt % release agent. The mixture is substantially free of wax. The mixture is pre-pressed into a loose formed mat, the mat is then pressed between two dies at an elevated temperature and pressure and for a sufficient time to further reduce the thickness of the mat to form a thin-layer composite of predetermined thickness, and the isocyanate resin is allowed to interact with the lignocellulosic fiber such that the resultant thin-layer composite has a predetermined resistance to moisture. The method further includes coating at least one surface of the thin-layer lignocellulosic composite with a coating composition including from about 5% to about 100% by weight of at least one thermoplastic acrylic polymer; from about 0.1% and to 20% by weight titanium dioxide; and water. The coating composition has a basic pH, a solids ratio of from about 58% to about 69% by weight, and is substantially free of quartz pigments.

In another aspect, the invention is a thin-layer lignocellulosic composite. The composite includes a mixture of no more than about 99 wt % of at least one type of lignocellulosic fiber, wherein the fiber comprises a predetermined moisture content of at least about 4%, at least about 1 wt % of an organic isocyanate resin, a release agent, and a tackifier. The mixture is substantially free of added wax and is pressed between two dies at an elevated temperature and pressure and for a sufficient time to form a thin-layer composite of predetermined thickness, allowing the isocyanate resin to interact with the lignocellulosic fiber such that the resultant thin-layer composite has a predetermined resistance to moisture. The thin-layer lignocellulosic composite is coated with a coating composition including from about 50% to about 100% by weight of at least one thermoplastic acrylic polymer; from about 0.1% and to 20% by weight titanium dioxide; and water. The coating composition has a basic pH, a solids ratio of from about 58% to about 69% by weight, and is substantially free of quartz pigments.

It is to be understood that the invention is not limited in its application to the specific details as set forth in the following description, figures and claims. The invention is capable of other embodiments and of being practiced or carried out in various ways.

### BRIEF DESCRIPTION OF THE FIGURES

FIG. 1 illustrates an embodiment of a method that may be used to make a thin-layer wood composite doorskin.

FIG. 2 illustrates an embodiment of a method used to make water-resistant thin-layer wood composites in accordance with an embodiment of the present invention where panel (a) shows mixing of the lignocellulosic fiber and resin; panel (b) shows forming the composite into a loose formed mat; panel (c) shows spraying the loose formed mat with release agent; panel (d) shows pressing the mat between two dies; (e) shows the resultant thin-layered composite product; and (f) shows coating the thin-layered composite with the present coating composition.

### DETAILED DESCRIPTION OF ILLUSTRATIVE EMBODIMENTS

In one aspect, the present invention is an aqueous composition for coating articles including isocyanate resins therein. The coating composition includes from about 50% to about 100% by weight of at least one thermoplastic acrylic polymer. In some embodiments, the acrylic polymer is present in an amount from about 10% to about 40% by weight, in other embodiments, from about 15% to about 35% by weight, and in other embodiments, from about 20% to about 30% by weight.

The thermoplastic acrylic polymer may be a homopolymer or a copolymer. The thermoplastic acrylic polymer may include monomer units selected from one or more of acrylic acid, butyl acrylate, 2-ethylhexyl acrylate, methyl acrylate, ethyl acrylate, acrylonitrile, methyl methacrylate, trimethylolpropane triacrylate, and combinations thereof.

In embodiments where the thermoplastic acrylic polymer is a copolymer, the copolymer may include monomer units selected from the group consisting of vinyl aromatics and combinations thereof. The vinyl aromatic monomer group may be styrene, α-methyl styrene, o-methyl styrene, p-methyl styrene, p-tert-butyl styrene, 1,3-dimethyl styrene, 1,3-butadiene, 2,4-butadiene, and combinations thereof.

The present composition further includes titanium dioxide. Titanium dioxide may be present in the composition in an amount from about 0.1% to about 20% by weight of the total composition, in some embodiments from about 0.5% to about 10%, in other embodiments from about 0.5% to about 5%, and in other embodiments from about 0.75% to about 3%.

The inventors unexpectedly discovered that the present composition may include a reduced amount of titanium dioxide relative to typical primer compositions. Higher concentrations (typically from about 30 to about 45 wt %) of titanium dioxide are typically required in primer compositions to cover resin spots. Those having ordinary skill in the art will recognize that resin spots typically form on articles including resins where the resins coagulate within the article. These spots are typically difficult to cover without high levels of titanium dioxide. The present coating composition achieves the desired characteristics of even cover of the article at reduced concentrations of titanium dioxide.

The composition further includes water. Water is preferably included in the composition at a concentration from about 10% to about 40% by weight of the total composition. In some embodiments, water is present in an amount from about 15% to about 35% by weight of the total composition, in other embodiments, in an amount from about 20% to about 30% by weight of the total composition.

The composition preferably has a basic pH. In some embodiments, the pH is from about 7 to about 14, in other embodiments, from about 8 to about 11. A basic pH may aid in the prevention of coagulation of the acrylic component of the present composition.

The present composition may also include at least one pH stabilizer to maintain a basic pH. Exemplary pH stabilizers include those known in the art, for example amine pH stabilizers. An example of an exemplary pH stabilizer may be dimethylamino ethanol (DMAE). When included, a pH stabilizer may be present in an amount from about 0.1 to about 3 wt %, in some embodiments from about 0.1 to about 2 wt %.

The present composition may also contain from about 1% to about 30% by weight thickening agents. Thickening agents contemplated as useful in the present composition include one or more of clay, aluminum silicates, caolin clay, magnesium silicates, calcined clays and combinations thereof. In some embodiments, the thickening agent is present in an amount from about 5% to about 25% by weight, in other embodiments, from about 10% to about 20% by weight.

It may be desirable to include at least one pigment in the present composition to impart color characteristics to the composition. Pigments known in the art are contemplated as being useful in the present invention. Any combination of pigments may be used to give a desired color and/or effect to the present coating composition.

The pigments may be included in an amount to provide a pigment volume concentration (PVC) load of from about 30% to about 40%, in some embodiments, from about 32% to about 39%, in other embodiments from about 34% to about 38%. Those having ordinary skill in the art will recognize that “PVC” means the concentration of pigment (based on volume) in a coating.

In some embodiments, the present composition may include at least one additional component selected from the group consisting of surfactants, dispersants, organic solvents, fungicides, bactericides, catalysts, rheological agents, extenders, biocides, and combinations thereof.

Surfactants may be included in the present composition to lower surface tension, prevent foaming of the composition during formation, and/or to enhance spreadability of the present composition.

Suitable surfactants contemplated as useful in the present invention include mineral oils, silicones, glycols, polyethylene, ethers, Trithon X-405, and combinations thereof. Surfactants may be present in an amount from about 0% to about 10% by weight, in some embodiments, from about 0.05% to about 8% by weight, in other embodiments, from about 0.1% to about 1% by weight.

Dispersants may optionally be included in the present composition and may prevent coagulation of solids in the composition.

Suitable dispersants contemplated as useful in the present invention include one or more of non-ionic, anionic, and cationic dispersants such as 2-amino 2-methyl 1-propanol (AMP), dimethyl amino ethanol (DMAE), potassium tripolyphosphate (KTPP), trisodium polyphosphate (TSPP), citric acid and other carboxylic acids, and the like, polymers such as homopolymers and copolymers based on polycarboxylic acids, including those that have been hydrophobically- or hydrophilically-modified, e.g., polyacrylic acid or polymethacrylic acid or maleic anhydride with various monomers such as styrene, acrylate or methacrylate esters, diisobutylene, and other hydrophilic or hydrophobic comonomers, and salts of the aforementioned polymers, as well as mixtures of these dispersants. Dispersants, when included in the present composition, may be present in an amount from about 0.3 to about 2% by weight, in some embodiments, from about 0.3 to about 1% by weight.

Suitable organic solvents contemplated as useful in the present composition include one or more of ethers and alcohols. In some embodiments, solvents may be one or more of dipropylene glycol monobutyl ether, 1,3-dihydroxymethyl-5,5-dimethylhydantoin, dimethyl amino ethanol, ethylene glycol n-butyl ether, dipropylene glycol methyl ether, and combinations thereof. The solvents may be included in the composition in a concentration of from about 0.01% to about 10%, in some embodiments from about 0.02% to about 5%, in other embodiments from about 0.03% to about 3%, all by weight of the total composition.

Solvents may be useful for coalescing pigments with the binders included in the present coating composition.

Fungicides contemplated as useful in the present invention include those known in the art as being effective to prevent the development of fungi in coating compositions. Suitable fungicides may be one or more of halogenated acetylene alcohols, diphenyl mercuric dodecenyl succinate, o-phenylphenol and its sodium salt, tri-chlorophenols and their sodium salts, dithiocarbamate and derivatives such as ferbam, ziram, maneb, mancozeb, zineb, propineb, metham, thiram, the complex of zineb and polyethylene thiuram disulfide, dazomet, and mixtures of these with copper salts; nitrophenol derivatives such as dinocap, binapacryl, and 2-sec-butyl-4,6-dinitrophenyl isopropyl carbonate; heterocyclic structures such as captan folpet, glyodine, dithianon, thioquinox, benomyl, thiabendazole, vinolozolin, iprodione, procymidone, triadimenol, triadimefon, bitertanol, fluoroimide, triarimol, cycloheximide, ethirimol, dodemorph, dimethomorph, thifluzamide, and, quinomethionate; miscellaneous halogenated fungicides such as: chloranil, dichlone, chloroneb, tricamba, dichloran, and polychloronitrobenzenes; fungicidal antibiotics such as: griseofulvin, kasugamycin and streptomycin; miscellaneous fungicides such as: diphenyl sulfone, dodine, methoxyl, 1-thiocyano-2,4-dinitrobenzene, 1-phenylthiosemicarbazide, thiophanate-methyl, and cymoxanil; as well as acylalanines such as, furalaxyl, cyprofuram, ofurace, benalaxyl, and oxadixyl; fluazinam, flumetover, phenylbenzamide derivatives such as those disclosed in EP 578586 A1, amino acid derivatives such as valine derivatives disclosed in EP 550788 A1, methoxyacrylates such as methyl (E)-2-(2-(6-(2-cyanophenoxy)pyrimidin-4-yloxy)phenyl)-3-methoxyacrylate; benzo(1,2,3)thiadiazole-7-carbothioic acid S-methyl ester: propamocarb; imazalil; carbendazim; myclobutanil; fenbuconazole; tridemorph; pyrazophos; fenarimol; fenpiclonil; pyrimethanil; carbamic acid; and butyl-3-iodo-2-propynl ether, methyl benzimidazole 2-yl carbamate, and combinations thereof.

Fungicides, when included, may be present in an amount from about 0.01% to about 10%, in other embodiments from about 0.02% to about 8%, in some embodiments, from about 0.05% to about 2%, all by weight.

Bactericides contemplated as useful in the present invention are those known in the art as being efficient bactericides in coating compositions. Suitable bactericides may include one or more of active chlorine (i.e., hypochlorites, chloramines, dichloroisocyanurate and trichloroisocyanurate, wet chlorine, chlorine dioxide etc.), active oxygen (peroxides, such as peracetic acid, potassium persulfate, sodium perborate, sodium percarbonate and urea perhydrate), iodine (iodpovidone (povidone-iodine, Betadine), Lugol's solution, iodine tincture, iodinated nonionic surfactants), concentrated alcohols (mainly ethanol, 1-propanol, called also n-propanol and 2-propanol, called isopropanol and mixtures thereof; further, 2-phenoxyethanol and 1- and 2-phenoxypropanols are used), phenolic substances, such as phenol (also called “carbolic acid”), cresols (called “Lysole” in combination with liquid potassium soaps), halogenated (chlorinated, brominated) phenols, such as hexachlorophene, triclosan, trichlorophenol, tribromophenol, pentachlorophenol, Dibromol and salts thereof), cationic surfactants, such as some quaternary ammonium cations (such as benzalkonium chloride, cetyl trimethylammonium bromide or chloride, didecyldimethylammonium chloride, cetylpyridinium chloride, benzethonium chloride) and others, non-quarternary compounds, such as chlorhexidine, glucoprotamine, octenidine dihydrochloride etc.), strong oxidizers, such as ozone and permanganate solutions; heavy metals and their salts, such as colloidal silver, silver nitrate, mercury chloride, phenylmercury salts, copper sulfate, copper oxide-chloride etc., and properly concentrated strong acids (phosphoric, nitric, sulfuric, amidosulfuric, toluenesulfonic acids) and alkalis (sodium, potassium, calcium hydroxides).

Bactericides, when utilized, may be included in the present composition in an amount from about 0.01% to about 10%, in other embodiments from about 0.02% to about 8%, in some embodiments, from about 0.05% to about 2%, all by weight.

Those having ordinary skill in the art will recognize that any fungicide, bactericide, mold inhibitor and/or biocide that does not negatively affect the desirable properties of the present composition may be utilized in the present composition.

It may also be desirable to include one or more rheological agents in the present composition. Those having ordinary skill in the art will recognize that rheological agents are agents that improve the flow and deformation of the composition. Suitable rheological agents contemplated as useful in the present invention include one or more of sodium polyacrylates and other polyacrylate rheological agents, water soluble or water swellable polymers that have chemically attached hydrophobic groups which are capable of non-specific hyrdrophobic associations, such as polyvinyl alcohol (PVA), hydrophobically-modified, alkali soluble emulsions known in the art as HASE emulsions, alkali-soluble or alkali-soluble emulsions known in the art as ASE emulsions, hydrophobically-modified ethylene oxide-urethane polymers known in the art as HEUR thickeners, and cellulosic thickeners such as hydroxymethyl cellulose (HMC), hydroxyethyl cellulose (HEC), hydrophobically-modified hydroxy ethyl cellulose (HMHEC), sodium carboxymethyl cellulose (SCMC), sodium carboxymethyl 2-hydroxyethyl cellulose, 2-hydroxypropyl methyl cellulose, 2-hydroxyethyl methyl cellulose, 2-hydroxybutyl methyl cellulose, 2-hydroxyethyl ethyl cellulose, 2-hydroxypropyl cellulose, hydrophobic modified ethoxylated aminoplast thickeners (HEAT), fumed silica, attapulgite clay and other types of clay, titanate chelating agents, and the like.

Rheological agents, when included in the present composition, may be present in an amount from about 0.01% to about 10%, in some embodiments, from about 0.1% to about 5%, in other embodiments, from about 0.5% to about 3%, all by weight.

Catalysts may also be included in the present composition to provide additional cross-linking. In some embodiments, polycarbodiimide and/or aziridine are contemplated as useful catalysts.

Catalysts, when utilized, may be present in a concentration of from about 0.3 to about 1.3% by weight, in some embodiments, from about 0.3 to about 0.63%, in other embodiments, from about 0.63 to about 1.25%.

In some embodiments, it may be desirable to add extenders to the present compositions. Suitable extenders include one or more of talcs, chlorites, kaolin clays, and carbonates. The extenders may be precipitated or unprecipitated. In some embodiments, the extenders are used as extenders for the titanium dioxide component of the present invention. When included, extenders may be present in an amount from about 2% to about 40% of the present composition, in some embodiments, from about 5% to about 35%, in other embodiments, from about 6% to about 30%, all by weight.

The present compositions may be substantially free of quartz pigments. The present compositions may also be substantially free of thermoset polymers.

Other additives known in the art as being useful in coating compositions, such as primer compositions, may be included in the present coating compositions. Such additives, known to those having ordinary skill in the art, are intended to be included in the present description.

The present coating compositions have a viscosity from about 1 to about 3 Zahn cups for about 32-36 seconds. The solids content may be from about 55 wt % to about 75 wt %, in some embodiments from about 60 wt % to about 67 wt %, in other embodiments from about 62 wt % to about 65 wt %. The solids content may also be described in terms of % by volume. As a volume percentage, the solids content may be from about 45 vol % to about 60 vol %, in some embodiments between from 49 vol % to about 53 vol %.

In another aspect, the invention is a method for making a coating composition for coating articles including isocyanate resins. The method includes forming a first grind phase by grinding water, at least one surfactant and at least one solvent together. Suitable surfactants and solvents are set forth above. The first grind phase should include concentrations of the various components as set forth in the description of the coating composition above.

The first grind phase may be conducted at a temperature of from about 80° F. to about 120° F., in some embodiments from about 90° F. to about 110° F.

Additional components that may be included in the first grind phase include one or more of a pH stabilizer, additional solvents, biocides, fungicides, and bactericides all as described above. Components added during the first grind phase may be those that take the longest to grind.

After formation of the first grind phase, a second grind phase is formed by grinding titanium dioxide into the first grind phase. The second grind phase may further include surfactants, thickeners, pigments extenders, and other components as described above. The components added to the second grind phase are typically those components taking less time to grind than the components added to the first grind phase.

It may be desirable in some embodiments to also add pigments, as discussed above, to the second grind phase.

The second grind phase may be conducted at a temperature of from about 80° F. to 120° F., in some embodiments from about 90° F. to about 110° F.

The second grind phase should continue until a paste is formed having a Hegman of no greater than about 4. Those having ordinary skill in the art will recognize that the average particle size of a paste having a Hegman of about 4 will be from about 5 to about 8 μm. Standard primer compositions typically have a particle size of from about 3.5 to about 4.5 μm. The present method produces coating compositions having larger particle sizes while maintaining, and often improving, the coating characteristics.

After completion of the second grind phase, the paste may be added to a let-down composition including water, at least one thermoplastic acrylic polymer as described above, and at least one rheological agent as described above, while agitating the let-down composition.

In some embodiments, it may be desirable to reduce the temperature of the paste formed during the second grind phase to below about 100° F. before adding the paste to the let-down phase. In other embodiments, it may be desirable to reduce the temperature of the paste formed during the second grind phase to ambient temperatures before adding the paste to the let-down phase.

When pigments are added during the second grind phase, the let-down phase should include a sufficient concentration of water to form a coating composition having a pigment volume concentration of from about 30% to about 40%.

The present invention provides for the manufacture of coated thin-layer lignocellulosic composites that include levels of isocyanate-based resins that inhibit the composite from shrinking and swelling after exposure to the elements. The invention may be applied to various types of lignocellulosic thin-layer composites to generate structural units that may be exposed to weathering by heat, moisture, air, and the like. In an embodiment, the present invention describes a method to make wood-based doorskins that are resistant to shrinking and swelling.

Thus, in an embodiment, the present invention comprises a method to produce a coated thin-layer lignocellulosic composite having increased resistance to moisture-induced shrinking and swelling comprising: (a) forming a lignocellulosic composite mixture comprising at least one type of lignocellulosic fiber comprising a predefined moisture content of at least about 1 wt % and at least 5 wt % of an organic isocyanate resin, at least about 0.1 wt % tackifier, and at least about 0.1 wt % release agent, wherein the mixture is substantially free of added wax; (b) prepressing the mixture into a loose formed mat; and (c) pressing the mat between two dies at an elevated temperature and pressure and for a sufficient time to further reduce the thickness of the mat to form a thin-layer composite of predetermined thickness, and to allow the isocyanate resin to interact with the lignocellulosic fiber such that the resultant thin-layer composite has a predetermined resistance to moisture.

The present invention also comprises coated thin-layer lignocellulosic composites made by the methods of the invention. Thus, in another embodiment, the present invention also comprises a coated thin-layer lignocellulosic composite comprising a mixture of no more than about 98 wt % of at least one type of lignocellulosic fiber, wherein the fiber has a predetermined moisture content of at least about 4 wt %, and at least 5 wt % of an organic isocyanate resin, at least about 0.1 wt % tackifier, and at least about 0.1 wt % release agent, wherein the release agent may include a wax and the mixture is substantially free of added wax, and wherein the mixture is pressed between two dies at an elevated temperature and pressure and for a sufficient time to form a thin-layer composite of predetermined thickness, and to allow the isocyanate resin to interact with the lignocellulosic fiber such that the resultant thin-layer composite has a predetermined resistance to moisture.

The lignocellulosic fiber comprises a material containing both cellulose and lignin. Suitable lignocellulosic materials may include wood particles, wood fibers, straw, hemp, sisal, cotton stalk, wheat, bamboo, jute, salt water reeds, palm fronds, flax, groundnut shells, hard woods, or soft woods, as well as fiberboards such as high density fiberboard, medium density fiberboard, oriented strand board and particle board. In an embodiment, the lignocellulosic fiber is refined. As used herein, refined fiber comprises wood fibers and fiber bundles that have been reduced in size, from other forms of wood such as chips and shavings. The refined wood fiber is normally produced by softening the larger wood particles with steam and pressure and then mechanically grinding the wood in a refiner to produce the desired fiber size. In an embodiment, the lignocellulosic fiber of the thin-layer composites of the present invention comprise wood fiber.

As used herein, a thin-layer composite comprises a flat, planar structure that is significantly longer and wider than it is thick. Examples of thin-layer lignocellulosic composites include wood-based doorskins that are used to cover the frame of a door to provide the outer surface of the door. Such doorskins may be only about 1 to 5 mm thick, but may have a surface area of about 20 square feet (1.86 square meters) or more. Other thin-layer lignocellulosic products may include Medium Density Fiberboard (MDF), hardboard, particleboard, Oriented Strand Board (OSB) and other panel products made with wood. These products are normally 3 to 20 mm in thickness.

In an embodiment, the lignocellulosic composite is substantially free of added wax. As used herein, the term “added wax” is intended to include wax added to the mixture as a distinct component. Similarly, as used herein, “substantially free of added wax” is intended to include composites having no wax, as well as composites having a negligible amount of wax at concentrations that would not materially affect the composites, where the wax is a part of a different component of the mixture, for example the tackifier and/or release agent. For example, a composite having less than about 0.4% wax may be encompassed by the term “substantially free of added wax.” In some embodiments, the composite is free of added wax. In some embodiments, various components, such as, for example, the tackifier or the release agent, may include certain amounts of wax. Embodiments in which the tackifier and/or the release agent include wax are considered to be substantially free of added wax.

The lignocellulosic mixture of the present invention further includes at last one tackifier. As used herein, the term “tackifier” is intended to include those compounds typically used in the adhesive industry to impart and/or improve the stickiness of adhesives. In the present invention, a tackifier may be blended into the mixture prior to pressing the mixture to form the present thin-layer lignocellulosic composites.

Without being bound by theory, it is believed that the tackifier enhances the interaction of the lignocellulosic fibers and the isocyanate resins, while enabling release of the composites from the dies after pressing.

Tackifiers contemplated as useful in the present invention include those tackifiers known in the adhesive industry. Suitable tackifiers include one or more tackifiers selected from rosins, lignins, hydrogenated rosins, hydrocarbons, hydrogenated hydrocarbons, pure monomers, hydrogenated pure monomers, terpene resins, and water-based dispersions of each of these. Lignosulfates, polyvinylalcohol resins, and acrylic resins are also contemplated as useful tackifiers in accordance with the present invention.

Examples of rosins and hydrogenated rosins (either fully or partially hydrogenated) include, but are not limited to, gum rosins, wood rosins, and tall oil rosins. Examples of hydrocarbons and hydrogenated hydrocarbons (either fully or partially hydrogenated) include, but are not limited to, C5 aliphatic hydrocarbon resins, such as trans-1,3-pentadiene, cis-1,3-pentadiene, 2-methyl-2-butene, dicyclopentadiene, cyclopentadiene, and cyclopentene; C9 aromatic hydrocarbons, such as vinyl toluenes, dicyclopentadiene, indene, methylstyrene, styrene, and methylindenes; and C5/C9 aliphatic/aromatic hydrocarbons, such as any combination of C5 aliphatic hydrocarbons and C9 aromatic hydrocarbons. Examples of terpene resins include, but are not limited to, thermoplastic terperene phenolic resins, terpene phenolic resins, polyterpene resins, styrenated terpene resins, and beta-pinene.

In the present invention, tackifiers may be added to the mixture at a concentration of from about 0.1% to about 5 wt %, in other embodiments from about 1% to about 2 wt %, and in some embodiments at a concentration of about 1.5 wt %.

As described herein, the lignocellulosic mixtures of the present invention are pressed into thin-layers using flat or molded dies at conditions of elevated temperature and pressure. In an embodiment, the mixture is initially formed into a loose formed mat, and the mat is placed in the die press. Because the composite includes amounts of resin that are sufficient to increase the water resistance of the composite mixture, the composite may stick to the surface of the dies that are used to press the mat into the resultant thin layer composite. Thus, in an embodiment, the method includes steps to reduce sticking of the thin-layer composite to the dies.

In an embodiment, the method includes exposing the lignocellulosic composite mixture to a release agent prior to pressing the composite between the dies. In an embodiment, the release agent comprises an aqueous emulsion of surfactants and polymers. In one embodiment, the release agent is not a wax. For example, the release agent may comprise compounds used in the doorskin manufacturing industry such as, but not limited to, PAT®7299/D2 or PAT®1667 (Wurtz GmbH & Co., Germany).

The release agent may be added directly to the lignocellulosic composite mixture as an internal release agent prior to pre-pressing the mixture into a loose formed mat. Alternatively and/or additionally, the release agent may be sprayed on the surface of the mat before the mat is pressed into a thin layer.

Where the release agent is added directly to the mixture as an internal release agent, the amount of release agent added may range from about 0.1 to about 4 wt % of the mixture, in other embodiments from about 0.25 wt % to about 3 wt %, in other embodiments from about 0.5 wt % to about 1.5 wt %. In one embodiment, about 0.8 wt % release agent is used.

Where the release agent is sprayed onto a surface of the mat, the amount of release agent sprayed onto the mat surface may comprise from about 0.1 to about 8.0 grams solids per square foot (about 1.1 to about 86.1 grams per square meter) of mat surface. In another embodiment, the amount of release agent sprayed on the mat surface may comprise about 4 grams solids per square foot (about 43 grams per square meter) of mat surface. The release agent may be applied as an aqueous solution. In an embodiment, an aqueous solution of about 25% release agent is applied to the mat surface. When the thin-layer composite comprises a doorskin, the release agent may be applied to the surface of the mat that corresponds to the surface that will become the outer surface of the doorskin.

The selected release agent(s) should be release agents that do not interfere with subsequent processing of the resultant thin-layer composites, for example, priming and/or gluing of the final product. Release agents will typically migrate to the surface of a composite during pressing and remain at or on the surface. Some release agents, such as fatty acid release agents, are known to migrate and then interfere with subsequent processing of the composite. Release agents contemplated as useful in the present invention should include those that would not significantly interfere with subsequent processing.

In an embodiment, the thin-layered lignocellulosic composite is colored. For example, in one embodiment, the release agent may comprise a pigment. In this way, an even coloring is applied to the thin-layered lignocellulosic composite. In some embodiments, a tinted release agent would facilitate subsequent priming or painting of the door.

Thus, the coated thin-layer lignocellulosic composites of the present invention may comprise wood fibers as well as a tackifier and/or a release agent. For example, in an embodiment, the present invention comprises a wood composite comprising a mixture of: (i) no more than 98 wt % of a wood fiber, wherein the wood fiber has a predetermined moisture content of at least about 4%; (ii) at least about 1 wt % of an organic isocyanate resin; (iii) at least about 0.1 wt % of a tackifier; (iv) optionally, at least about 0.1% internal release agent by weight and/or at least about 0.1 grams release agent per square foot (about 1.1 grams per square meter) on the surface of the composite; and (v) at least one side coated with a coating composition such as those described above.

Other methods may be used to reduce sticking of the lignocellulosic composite to the dies used for making the resultant thin-layer composite. Thus, in another embodiment, at least one surface of the die used to press the mat is exposed to an anti-bonding agent. In an embodiment, exposing the die to an anti-bonding agent may comprise coating at least one of the dies used to press the mat with an anti-bonding agent. In an embodiment, coating the die may comprise baking the anti-bonding agent onto the die surface.

In an embodiment, the release agent is not the same as an anti-bonding agent. The release agent comprises a compound that will not interfere with subsequent processing of the resulting thin-layer composite. In contrast, the anti-bonding agent may comprise compositions known in the art of pressing wood composites as being effective in preventing sticking to the pressing dies, but that may be problematic if included as part of the composite.

For example, in an embodiment, the anti-bonding agent used to coat the die surface can be one or more of silane, silicone, siloxane, fatty acids, and polycarboxyl compounds. Thus, the anti-bonding agent used to coat the die surface may comprise anti-bonding agents known in the art of die pressing such as, but not limited to, CrystalCoat MP-3 13 and Silvue Coating (SDC Coatings, Anaheim, Calif.), lso-Strip-23 Release Coating (ICI Polyurethanes, West Deptford, N.J.), aminoethylaminopropyltrimethoxysilane (Dow Corning Corporation), or the like.

For thin-layer doorskins, the die that is coated with the anti-bonding agent may correspond to the die used to press the outside surface of the doorskin. Alternatively, both dies may be coated with an anti-bonding agent. In an embodiment, the amount of anti-bonding agent used to coat the die surface may range in thickness from about 0.0005 to about 0.010 inches (i.e., about 0.0127 mm to about 0.254 mm). Thus, in one embodiment, the amount of anti-bonding agent used to coat the die surface comprises about 0.003 inches (i.e., about 0.0762 mm).

In an embodiment, coating the die comprises baking the anti-bonding agent onto the die surface. For example, in one embodiment, the step of baking the anti-bonding agent onto the die surface may comprise the steps of: (i) cleaning the die surface substantially free of dirt, dust and grease; (ii) spraying from about 0.0005 to about 0.010 inches (about 0.5 to about 10 mils or about 0.0127 to about 0.254 mm) of a 50% solution of the anti-bonding agent onto the die; and (iii) baking the die at greater than 300° F. (149° C.) for about 1 to 4 hours.

In an embodiment, the step of exposing the pre-pressed mat to at least one release agent and/or anti-bonding agent may comprise adding an internal release agent and/or spraying one side of the mat with a release agent and also coating at least one die surface with an anti-bonding agent. In this embodiment, the side of the mat coated with the release agent may be the surface opposite to the surface of the mat exposed to the coated die.

For example, in an embodiment, the present invention comprises a method to produce a coated thin-layer wood composite having increased water resistance comprising: (a) forming a mixture comprising: (i) a refined wood fiber comprising a predefined moisture content of at least about 4%; (ii) a tackifier; (iii) at least about 1 wt % of an organic isocyanate resin; and (iv) a release agent; (b) pre-pressing the mixture into a loose formed mat; (c) optionally, spraying one surface of the mat with a release agent; (d) pressing the mat between two dies at an elevated temperature and pressure and for a sufficient time to further reduce the thickness of the mat to form a thin-layer composite of predetermined thickness, and to allow the isocyanate resin to interact with the wood fibers such that the doorskin has a predetermined resistance to moisture, wherein at least one of the die surfaces has been coated with an anti-bonding agent; and (3) coating at least one surface of the thin-layer wood composite with a coating composition as described above.

The thin-layered lignocelluiosic composites of the present invention may comprise a range of fiber compositions. Thus, in an embodiment, the lignocellulosic composite mixture comprises about 80% to about 98 wt % fiber.

The thin-layered composites of the present invention may comprise lignocellulosic fiber comprising a range of moisture levels. In an embodiment, the method does not require dehydrating the lignocellulosic fiber prior to treatment with the resin. Thus, in an embodiment, the lignocellulosic fiber comprises from about 4% to about 15% moisture content by weight. In another embodiment, the lignocellulosic fiber may comprise from about 8% to about 13% moisture by weight. In another embodiment, the lignocellulosic fiber may comprise about 10% moisture by weight.

The organic isocyanate resin used may be aliphatic, cycloaliphatic, or aromatic, or a combination thereof. Monomeric, oligomeric, and polymeric isocyanates are contemplated as useful in the present invention. In an embodiment, the isocyanate may comprise diphenylmethane diisocyanate (MDI) or toluene diisocyanate (TDI) such as Lupranate®M20FB Isocyanate (BASF Corporation, Wyandotte, Mich.). For example, in an embodiment, the isocyanate comprises diphenylmethane-4,4′-diisocyanate. Or, in an embodiment, the isocyanate is selected from the group consisting of toluene-2,4-diisocyanate; toluene-2,6-diisocyanate; isophorone diisocyanate; diphenylmethane-4,4′-diisocyanate; 3,3′-dimethyldiphenylmethane-4,4′-diisocyanatem m-phenylene diisocyanate; p-phenylene diisocyanate; chlorophenylene diisocyanate; toluene-2,4,6-triisocyanate; 4,4′,4″-triphenylmethane triisocyanate; diphenyl ether 2,4,4′-triisocyanate; hexamethylene-1,6-diisocyanate; tetramethylene-1,4-diisocyanate, cyclohexane-1,4-diisocyanate; naphthalene-1,5-diisocyanate; 1-methoxyphenyl-2,4-diisocyanate; 4,4′-biphenylene diisocyanate; 3,3′-dimethoxy-4,4′-biphenyl iisocyanate; 3,3′-dimethyl-4,4′-biphenyl diisocyanate; 4,4′-dimethyldiphenylmethane-2,2′,5,5′-teaisocyanate; 3,3′-dichlorophenyl-4,4′-diisocyanate; 2,2′,5,5′-tetrachlorodiphenyl-4,4′-diisocyanate; trimethylhexamethylene diisocyanate; m-xylene diisocyanate; polymethylene polyphenylisocyanates; and mixtures thereof.

A range of isocyanate resin levels may be used to make the thin-layer composites of the present invention. Thus, in an embodiment, the mixture used to form the composite may comprise from about 1% to about 5 wt % resin solids, in some embodiments from about 2% to about 4 wt %. In another embodiment, the mixture may comprise about 3 wt % resin solids.

The conditions used to form the thin-layer composite include compressing the mixture at elevated temperature and pressure for sufficient time to allow the isocyanate resin to interact with the wood fibers such that the resultant thin-layer composite has a predetermined resistance to moisture. The exact conditions used will depend upon the equipment used, the exterior environment (e.g., temperature, elevation), the manufacturing schedule, the cost of input resources (e.g., starting materials, electric power), and the like. Also, varying the temperature may allow for changes to be made in the pressure used or the time of pressing; similarly, changes in pressure may require adjustment of the time and/or temperature used for pressing the thin-layer composites of the present invention.

A range of temperatures may be used to promote interaction of the isocyanate resin with the lignocellulosic fibers in the mixture. In an embodiment, the temperature used to press the mixture (or preformed mat) into a thin-layer composite may range from about 250° F. (121° C.) to about 400° F. (204° C.). In another embodiment, the temperature used to press the mixture (or preformed mat) into a thin-layer composite may range from about 280° F. (138° C.) to about 350° F. (177° C.). Or, a temperature that is in the range of from about 310° F. (154° C.) to about 330° F. (166° C.) may be used.

Similarly, the levels of the pressure applied during the pressing of the thin-layer composite may vary depending on a variety of factors, such as the nature of the thin-layer composite that is being formed, the equipment being used, environmental conditions, production capabilities, and the like. Thus, in an embodiment, the pressure during the pressing step may range from about 2500 psi (about 176 kg/cm²) to about 150 psi (about 10.5 kg/cm²). In another embodiment, the pressure may be applied in a step-wise manner. In another embodiment, the pressure during the pressing step ranges from about 1200 psi (about 84.3 kg/cm²) for about 5 to 20 seconds followed by 500 psi (about 35.16 kg/cm²) for 20 to 80 seconds. For example, in one embodiment, the pressure during the pressure step ranges from about 1200 psi (about 84.3 kg/cm²) for about 10 seconds to about 500 psi (about 35.16 kg/cm²) for about 50 seconds.

The thin-layer lignocellulosic composites of the present invention have increased resistance to moisture-induced shrinkage and swelling. As used herein, increased resistance to moisture comprises reduced shrinking and/or swelling of the thin-layer composite when the composite is exposed to conditions of low and high moisture, respectively, as compared to thin lignocellulosic composites made by other methods, or using non-isocyanate resins. The present coated thin-layer lignocellulosic composites have a moisture content after press of between about 4% and about 8 wt %, in some embodiments between 5% and about 7 wt %.

Thus, in an embodiment, when coated thin-layer composites of the present invention are exposed to an atmosphere where the moisture level is low, the composite of the present invention exhibits less shrinkage than thin-layer composites made with other resins. Also, in an embodiment, when coated thin-layer composites of the present invention are exposed to an atmosphere where the moisture level is high, the composite of the present invention exhibits less swelling than thin-layer composites made with other resins.

For example, in an embodiment, the coated thin-layer composite comprises up to 25% less linear expansion and thickness swelling after being immersed for 24 hours in 70° F. (21° C.) water than a thin-layer composite comprising comparable levels of an alternate resin, either isocyanate resins or non-isocyanate resins. Also in an embodiment, the predetermined resistance to moisture comprises a thickness swelling of less than 15% after being immersed for 24 hours in water at 70° F. (21° C.).

Also in an embodiment, doorskins made by the methods of the present invention are significantly less dense than doorskins made using traditional formaldehyde-based resins. Thus, in an embodiment, the coated thin-layer lignocellulosic composites of the present invention comprise a density of between about 48 pounds per cubic foot (about 769.0 kg/m³) and about 62 pounds per cubic foot (about 993.4 kg/m³), in some embodiments less than about 60 pounds per cubic foot (about 962 kg/m³). In another embodiment, the thin-layer lignocellulosic composites of the present invention may comprise a density of less than 55 pounds per cubic foot (about 881.5 kg/m³).

### Preparation of Coated Thin-Layer Wood Composites Having Increased Water Resistance

Several methods have been described herein to produce wood composites that exhibit increased resistance to moisture uptake and loss. It is believed that swelling and/or shrinking of wood is, at least partially, the result of water reacting with hydroxyl groups present in cellulose and hemicellulose. Thus, high moisture levels increase the amount of water bound to the wood fiber. Alternatively, in low humidity, water is lost from the wood fibers.

An aspect of the present invention is concerned with methods to employ low concentrations of isocyanate resins to improve the moisture-resistance of thin-layer lignocellulosic composites, such as, but not limited to, wood doorskins. Isocyanate resins such as diphenylmethane-4,4′-diisocyanate (MDI) and toluene diisocyanate (TDI) resin are highly effective in modifying the reactive groups present on cellulose fibers to thereby prevent the fibers from reacting with water. It is believed that the isocyanate forms a chemical bond between the hydroxyl groups of the wood cellulose, thus forming a urethane linkage.

In the present invention, a coated thin-layer wood composite that is resistant to water is provided with resin contents of between about 1% and about 5% and in some embodiments at levels between about 2% and about 4%. Doorskins are generally on the order of 1 to 5 mm in thickness, with a total surface area of 20 square feet (i.e., 1.86 square meters). When such thin-layer wood composites made with isocyanate resin are prepared using conventional pressing methods, the high resin levels cause the wood composite to stick to the pressing die used to prepare the doorskin after only a few pressing cycles.

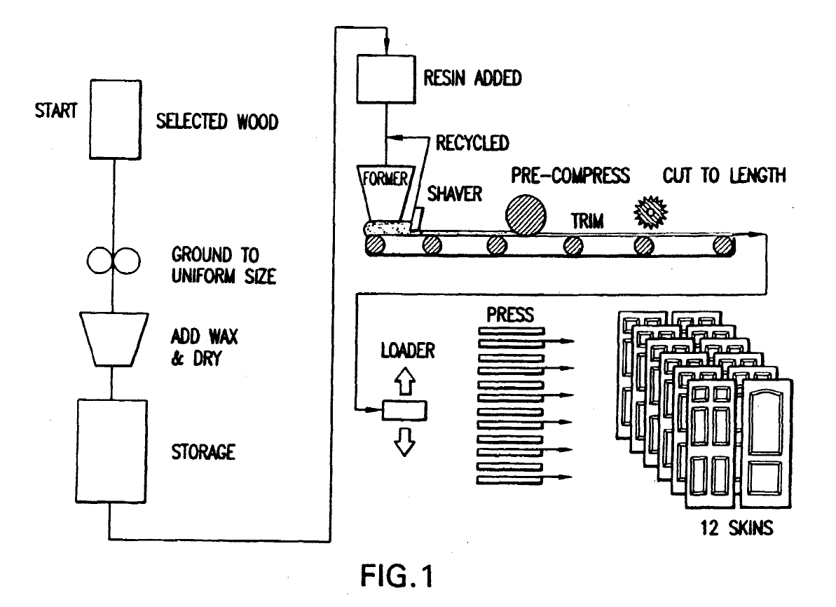

FIG. 1 shows an overview of a general method used to prepare doorskins. Generally, a selected wood starting material is ground to prepare fibers of a uniform size and the appropriate amount of wax added. At this point the preparation may be stored until further processing. The fiber/tackifier blend is then mixed with an appropriate binder resin (e.g., using atomization), until a uniform mixture is formed. It is also common to add the resin to the fiber prior to storage of the fiber.

The mixture may then be formed into a loose formed mat which is pre-shaped using a shave-off roller and pre-compressed to a density of about 6-8 pounds per cubic foot. After further trimming to the correct size and shape, the pre-pressed mat is introduced into a platen press, and compressed between two dies under conditions of increased temperature and pressure. For example, standard pressing conditions may comprise pressing at 320° F. at 1200 psi for 10 seconds followed by 50 seconds at 500 psi (i.e., about 160° C. at 84.3 kg/cm² for 10 seconds followed by 50 seconds at 35.2 kg/cm²). Generally, a recessed (female) die is used to produce the inner surface of the doorskin, and a male die shaped as the mirror image of the female die is used to produce the outside surface of the skin. Also, the die which is forming the side of the doorskin that will be the outer surface may include an impression to create a wood grain pattern or texture.

After pressing, the present coating composition may be applied to at least one surface of the thin-layer lignocellulosic composite to form the present coated thin-layer lignocellulosic composite. The coating composition may be applied by any means known in the art. In some embodiments, the coating may be applied by spraying and/or brushing the coating onto the thin-layer lignocellulosic composite. When sprayed, the application may be an airless spray.

The coating step may be conducted at a temperature of from about 180° F. to about 220° F., in some embodiments from about 190° F. to about 210° F. If application temperatures are too low, the coating composition may exhibit poor adhesion to the composite. If application temperatures are too high, the coating layer may blister and/or the coated composites may exhibit stacking difficulties when stored.

After cooling, the resulting doorskin is mounted onto a doorframe using a standard adhesive and employing mounting methods standard in the art.

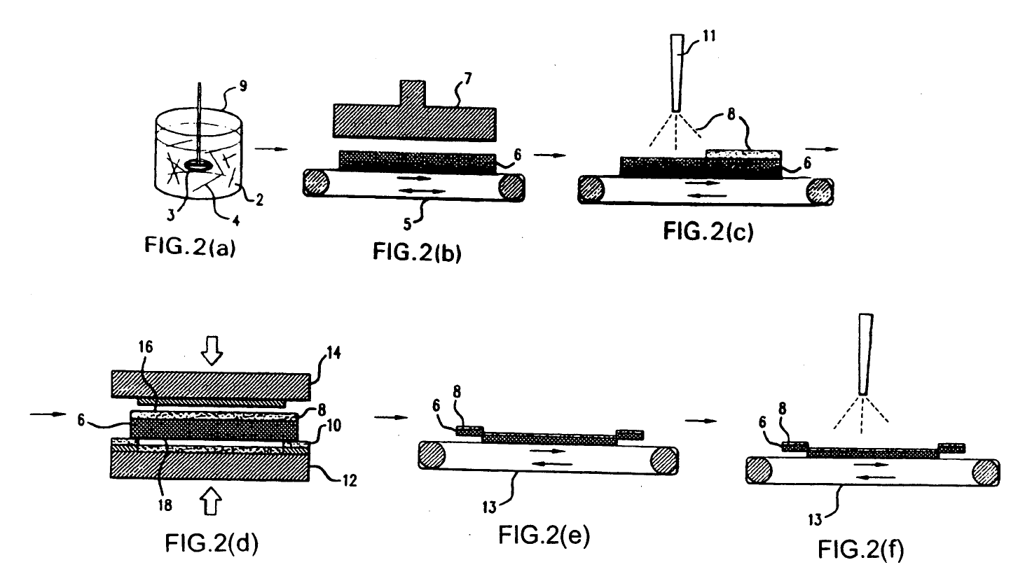

In an embodiment (FIG. 2), the present invention describes a method for making a thin-layer wood composite having increased water resistance comprising forming a wood composite mixture 2 comprising: (i) a refined wood fiber 4 having a predefined moisture content of about 4% to about 15%; (ii) about 0.1% to about 5.0% tackifier; (iii) from about 1.0% to about 5 wt % of an organic isocyanate resin; and (iv) optionally, at least about 1 wt % of an internal release agent (FIG. 2(a)). The mixture may be prepared in bulk using standard blowline blending of the resin and fibers. Or, blenders 9 having a means for mixing 3 such as a paddle or the like, may be used.

Next, the wood composite mixture may be formed into a loose formed mat in a forming box. The mat is then pre-shaped using a shave-off roller (not shown in FIG. 2) and precompressed using a roller or some other type of press 7 (FIG. 2(b)). The specific density of the mat may vary depending on the nature of the wood composite being formed, but generally, the mat is formed to have a density of about 6 to 8 pounds per cubic foot (i.e., 96.2-128.1 kg per cubic meter). After further trimming of the mat to the correct size and shape, at least one surface of the mat may be exposed to additional release agent 8 by spraying the release agent onto the surface of the mat 6 using a spray nozzle 11 (FIG. 2(c)). Also, shown in FIG. 2 are conveyors 5 and 13 as a means for transferring the wood composite from one station to another. It is understood that other means of supporting or transferring the thin-layer wood composite from one station to another, or supporting the composite during the processing steps may be used.

The mat 6 may then be placed between a male die 14 and a female die 12, and pressed at an elevated temperature and pressure and for a sufficient time to further reduce the thickness of the thin-layer composite and to allow the isocyanate resin to interact with the wood fibers (FIG. 2(d)). As described above, it is believed that by heating the wood composite in the presence of the resin, the isocyanate of the resin forms a urethane linkage with the hydroxyl groups of the wood cellulose. Replacement of the hydroxyl groups of the cellulose with the urethane linkage prevents water from hydrating or being lost from the cellulose hydroxyl groups. Thus, once the resin has cured, a doorskin having a predetermined resistance to moisture is formed. As described above, in an embodiment, one of the dies may be coated with an anti-bonding agent. FIG. 2 shows an embodiment in which the female die 12 is coated on its inner surface with an antibonding agent 10.

In alternative embodiments, both dies (12 and 14) are coated with anti-bonding agent. For example, this embodiment may be preferred where both die surfaces do not have a grain pattern, but are smooth. Or, in an embodiment, both inner die surfaces may be coated with an anti-bonding agent, and the use of release agent to coat the mat may vary depending upon the particular wood composite being prepared. Or, in an embodiment, the method may employ a release agent on the surface of the mat, without coating of the dies. In yet another embodiment, the method may employ an internal release agent in the mat, without coating of the dies.

Subsequently, the doorskin is allowed to cool (FIG. 2(e)) and then further processed (sizing and priming as described above) prior to being applied to a doorframe.

Thus, the invention describes using a release agent and/or anti-bonding agent to prevent the thin-layer wood composite from sticking to the pressing dies during production.

The release agent and/or anti-bonding agent used to prevent the mat from sticking to the dies during production may be applied to the mat in various ways. Generally, when the mat is used to produce a standard doorskin, one of the dies comprises a recess and is described as the female die. Referring to FIG. 2, usually the female die 12 is positioned underneath the lower surface 18 of the mat, which is the surface of the mat that is adhered to the underlying doorframe (i.e., the inner surface). The other (upper) surface of the mat 16 corresponds to the side of the doorskin that will be on the outside of the door. Often, this side of the doorskin will include a grain texture to enhance the decorative effect. The die 14 used to press the upper side of the mat (i.e. the eventual outside of the door) may be termed the male die. Thus, the male die includes a protruding portion that is the mirror image of the recess on the female die, and optionally, a grain-like pattern on the surface of the die.

In one embodiment, an anti-bonding agent is coated onto the bottom (female) die. Depending on the actual anti-bonding agent used, the coating may be baked onto the bottom die. In this way, the coated die may be used several times before recoating with additional anti-bonding agent. For example, in an embodiment, the step of baking the anti-bonding agent onto the die surface comprises the steps of (i) cleaning the die surface substantially free of any dirt, dust or grease; (ii) spraying about 0.003 inches (3 mils; 0.726 mm) of a 50% solution of the anti-bonding agent onto the die; and (iii) baking the die at over 300° F. (149° C.) for about 1-4 hours. In an embodiment, the step of cleaning the die comprises cleaning the die surface with a degreaser; wire brushing to remove solids; wiping the die surface with a solvent (such as acetone); and buffing with a cotton pad. The anti-bonding agent is then applied to provide a 3 mil thickness; and the die heated to bake the coating onto the die. In some embodiments, the die may be coated with multiple layers of anti-bonding, with the baking step occurring after only the final coat or after only some, but not all of the coats.

Under suitable conditions, the anti-bonding agent that is baked onto the die (or dies) is stable enough with respect to the pressing conditions such that the die(s) can be used for over 2000 pressing cycles prior to requiring another coating with additional anti-bonding agent. Anti-bonding agents that are suitable for baking onto the die surface include Crystalcoat MP-313 and Silvue (SDC Coatings, Anaheim, Calif.), ISO-Strip-23 Release Coating (ICI Polyurethanes, West Deptford, N.J.), aminoethlyaminopropyltrimethoxysilane (Dow Corning Corporation), or the like.

Although a preferred method to facilitate removal of the doorskin from the die uses a die coated with anti-bonding agent, other equivalent methods to facilitate nonsticking of the wood composite to the die may be incorporated into the methods of the present invention. For example, to facilitate release of the doorskin, the die(s) may be nickel plated, covered with a ceramic layer, or coated with fluorocarbons.

As described above, a release agent may be sprayed onto one of the surfaces of the pre-pressed mat prior to the mat being pressed between the dies. For example, and referring again to FIG. 2, a release agent 8 may be sprayed onto the upper surface 16 of the mat 6 which is exposed to the male die 14. Preferably, the release agent 8 sprayed directly onto the surface of the mat is a release agent that is compatible with the wood and resin making up the composite. Preferably, the release agent sprayed on the wood comprises compounds such as PAT®-7299/D2, PAT®-1667 (Wurtz GmbH & Co., Germany), and the like.

The amount of release agent sprayed onto at least one side of the mat may range from about 0.1 to about 8.0 grams solids per square foot (1.1 to 86.1 grams per square meter) of mat. For example, the release agent may be sprayed onto the mat as an approximately 25% aqueous solution. In an embodiment, the amount of release agent sprayed onto at least one side of the mat may comprise about 4 grams solids per square foot (i.e., 43.05 grams per square meter) of mat sprayed as an approximately 25% aqueous solution.

The release agent used to coat the mat is distinct from the anti-bonding agent used to coat the die surface(s). The anti-bonding agent used to coat the die surface(s) generally can be one or more of silane, silicone, siloxane, fatty acids, and polycarboxyl compounds that are known to be effective coating agents. These anti-bonding agents, however, are not always suitable for spraying directly on the wood mat (or incorporating into the wood composite) since they may interfere with later finishing of the wood product by priming and/or painting.

As described herein, the present invention describes the use of isocyanate resins to prepare wood composites. One of the advantages of using isocyanate resins rather than formaldehyde crosslinked resins is that less energy is needed to dry the wood fiber prior to pressing the mat. As described herein, traditional phenol-formaldehyde resins are not compatible with wood having a water content much greater than 8%, as the water tends to interfere with the curing process. Also, excess moisture in the wood fiber can cause blistering when pressed with melamine-formaldehyde resins or urea-formaldehyde resins. Thus, for wood having a moisture content of greater than 8%, the wood must be dried for the curing step, and then re-hydrated later. In contrast, isocyanate-based resins are compatible with wood having a higher water content and thus, curing with isocyanate-based resins may obviate the need for the drying and the re-hydrating steps associated with formaldehyde-based resins. Moreover, the use of isocyanate resins in place of formaldehyde-based resins results in a reduction of formaldehyde resins. The present concentration of isocyanate resins results in lower volatile organic compound (VOC) emissions. Accordingly, the present composites provide synergistic environmental improvements over previous thin-layer lignocellulosic composites.

In an embodiment, the press time and temperature may vary depending upon the resin used. For example, using a toluene diisocyanate (TDI) resin as opposed to diphenylmethane diisocyanate (MDI) resin may shorten the press time by as much as 10%. Generally, when using isocyanate resins, very high temperatures are not required; thus, isocyanate resins are associated with decreased energy costs and less wear on the boiler or other energy generator. Still, composites made at very low temperatures do not display sufficient resistance to moisture to be commercially useful. Thus, the temperature used for pressing may range from about 250° F. to about 400° F. (121° C. to 204° C.), or in some embodiments, from about 280° F. to about 350° F. (138° C. to 177° C.). In an embodiment, ranges from 310° F. (154° C.) to about 330° F. (166° C.) are preferred.

The pressure used during pressing may be constant, or varied in a step-wise fashion. Depending upon the selected temperature and pressure conditions used for pressing, the total pressing may range from about 30 seconds to about 2 minutes or more. Thus, the pressure during the pressing step may include ranges from about 2500 psi (about 176 kg/cm²) to about 150 psi (about 10.5 kg/cm²). Or, the pressure may be applied in a step-wise manner. For example, the pressure during the pressing step may range from about 1200 psi (about 84.3 kg/cm²) for about 5 to 20 seconds followed by 500 psi (about 35.16 kg/cm²) for 10 to 80 seconds. In one embodiment, the pressure during the pressure step ranges from about 1200 psi (about 84.3 kg/cm²) for about 10 seconds to about 500 psi (about 35.16 kg/cm²) for about 30 seconds.

Preferably, wood composites made by the method of the invention comprise significantly less linear expansion and swelling than wood composites made by conventional methods. Thus, doorskins made by the method of the present invention exhibit about 50% less linear expansion and thickness swelling than composite doorskins made with formaldehyde-based resins of the same content (such as, for example, 3% melamine-urea-formaldehyde doorskins) when boiled in water for 2 hours. Also, doorskins made by the present invention exhibit about 50% less linear expansion than non-isocyanate based doorskins when immersed in water for 24 hours at 70° F. (21.1° C.), a standard test used in the industry (ASTM D1037).

As described above, the thin-layer lignocellulosic composites of the present invention comprise a predetermined thickness, such that the resultant composite comprises a flat planar structure. In an embodiment, the predetermined thickness ranges from about 0.085 inches to about 0.250 inches (about 2.16 mm to about 6.35 mm). In an alternate embodiment, the predetermined thickness of the thin-layer composite may range from about 0.110 to about 0.130 inches (about 2.79 to about 3.30 mm).

Also in an embodiment, doorskins made by the methods of the present invention are significantly less dense than doorskins made using traditional formaldehyde-based resins. For a doorskin that is 0.12 inches (3.05 mm) thick and has 10% melamine-urea formaldehyde resin and 1.5% wax, the density is about 58 pounds per cubic foot (930 kg/m³). In contrast, doorskins of the present invention (3% MDI resin; 0.8% internal press release) may have a density as low as about 48 pounds per cubic foot (769.0 kg/m³).

The coated wood composites made by the method of the invention demonstrated significantly less linear expansion and swelling than wood composites made by conventional methods. Thus, doorskins made by the method of the present invention exhibited 50% less linear expansion and thickness swelling than composite doorskins made with formaldehyde based resins of the same content (e.g., 1% melamine-urea-formaldehyde doorskins) when boiled in water for 2 hours. Also, doorskins made by the present invention exhibited 50% less linear expansion than comparable formaldehyde-based doorskins than non-isocyanate based doorskins when immersed in water for about 24 hours at 70° F. (21.1° C.), a standard test used in the industry (ASTM D1037).

Also, coated doorskins made by the methods of the present invention were found to be significantly less dense than doorskins made using traditional formaldehyde-based resins.

Accordingly, the present methods form coated composites that have increased resistance to moisture-induced shrinking and/or swelling as compared to composites with similar concentrations of non-isocyanate resins. The present methods also may be used to form coated composites having comparable resistance to moisture-induced shrinking and/or swelling as composites having greater concentrations of isocyanate resins. The inventors, therefore, have developed methods and products demonstrating reduced emissions, while maintaining and improving the physical characteristics of the composites using concentrations previously understood to be unworkable.

The present methods also result in reduced energy costs, high-throughput production, and reduced over-all costs while maintaining the necessary moisture resistance of the composites.

It will be understood that each of the elements described above, or two or more together, may also find utility in applications differing from the types described. Although the invention has been illustrated and described as a method for high-throughput preparation of thin-layer lignocellulosic composites, such as doorskins, it is not intended to be limited to the details shown, since various modifications and substitutions can be made without departing in any way from the spirit of the present invention. As such, further modifications and equivalents of the invention herein disclosed may occur to persons skilled in the art using no more than routine experimentation, and all such modifications and equivalents are believed to be within the spirit and scope of the invention as described herein.

That which is claimed is:

1. An aqueous composition for coating articles including isocyanate resins, the composition comprising:
from about 50% and to about 100% by weight of at least one thermoplastic acrylic polymer;
from about 0.1% and to about 20% by weight titanium dioxide; and
water, wherein the composition has a basic pH, a solids ratio of from about 58% to about 69% by weight, and is substantially free of quartz pigments.

2. The composition according to claim 1, wherein the acrylic polymer is present in an amount from about 10% to about 40% by weight.

3. The composition according to claim 1, wherein the acrylic polymer comprises an acrylic copolymer.

4. The composition according to claim 1, wherein the acrylic polymer comprises monomer units selected from the group consisting of acrylic acid, butyl acrylate, 2-ethylhexyl acrylate, methyl acrylate, ethyl acrylate, acrylonitrile, methyl methacrylate, trimethylolpropane triacrylate, and combinations thereof.

5. The composition according to claim 4, wherein the acrylic polymer further comprises monomer units selected from the group consisting of vinyl aromatics and combinations thereof.

6. The composition according to claim 5, wherein the vinyl aromatic monomer groups are selected from the group consisting of styrene, α-methyl styrene, p-methyl styrene, o-methyl styrene, p-tert-butyl styrene, 1,3-dimethylstyrene, 1,3-butadiene, 2,4-butadiene, and combinations thereof.

7. The composition according to claim 1, wherein the titanium dioxide is present in an amount of from about 0.5% to about 5% by weight.

8. The composition according to claim 1, further comprising from about 1% to about 30% by weight thickening agents.

9. The composition according to claim 8, wherein the thickening agents are selected from the group consisting of clay, aluminum silicate, clays, magnesium silicates, and combinations thereof.

10. The composition according to claim 1, further comprising at least one additional component selected from the group consisting of surfactants, dispersants, organic solvents, fungicides, bactericides, catalysts, rheological agents, extenders, biocides, pH stabilizers and combinations thereof.

11. The composition according to claim 1, further comprising a pigment.

12. The composition according to claim 11, wherein the composition comprises a pigment volume concentration load of from about 30% to about 40%.

13. A method for making a primer composition, the method comprising:
forming a first grind phase by grinding water, at least one surfactant, and at least one co-solvent together;
forming a second grind phase by grinding titanium dioxide into the first grind phase;
grinding the second grind phase to form a paste having a Hegman of no greater than about 4; and
adding the paste to a let-down composition comprising water, at least one acrylic polymer, and at least one rheological agent while agitating.

14. The method according to claim 13, further comprising grinding thickening agents during the formation of the second grind phase.

15. The method according to claim 13, further comprising grinding extenders during the formation of the second grind phase.

16. The method according to claim 13, wherein the paste comprises particles having an average diameter of from about 5 μm to about 8 μm.

17. The method according to claim 13, wherein the step of adding the paste to a let-down composition comprises adding the paste at substantially ambient conditions.

18. The method according to claim 13, further comprising cooling the paste to a temperature below about 100° F. before adding the paste to the let-down composition.

19. The method according to claim 13, further comprising adding at least one catalyst to the let-down composition.

20. The method according to claim 13, wherein at least one pigment is added to the composition during formation of the second grind phase.

21. The method according to claim 13, wherein the let-down composition includes a sufficient concentration of water to form a primer having a pigment volume concentration from about 30% to about 40%.

22. A method of producing a thin-layer lignocellulosic composite having increased resistance to moisture-induced shrinking or swelling, the method comprising:
(a) forming a lignocellulosic composite mixture comprising at least one type of lignocellulosic fiber comprising a predetermined moisture content of at least about 4%, at least about 1 wt % of an organic isocyanate resin, at least about 0.1 wt % tackifier, and at least about 0.1 wt % release agent, wherein the mixture is substantially free of wax;
(b) pre-pressing the mixture into a loose formed mat;
(c) pressing the mat between two dies at an elevated temperature and pressure and for a sufficient time further reducing the thickness of the mat to form a thin-layer composite of predetermined thickness, and allowing the isocyanate resin to interact with the lignocellulosic fiber such that the resultant thin-layer composite has a predetermined resistance to moisture; and
(d) coating at least one surface of the thin-layer lignocellulosic composite with a primer comprising:
(i) from about 50% to about 100% by weight of at least one thermoplastic acrylic polymer;
(ii) from about 0.1% and about 20% by weight titanium dioxide; and
(iii) water, wherein the composition has a basic pH, a solids ratio of from about 58% to about 69% by weight, and is substantially free of quartz pigments.

23. The method according to claim 22, wherein the lignocellulosic fiber comprises wood.

24. The method according to claim 22, wherein the tackifier is selected from the group consisting of rosins, lignins, hydrocarbons, hydrogenated hydrocarbons, pure monomers, hydrogenated pure monomers, water-based dispersions, and combinations thereof.

25. The method according to claim 22, further comprising spraying additional release agent onto the loose-formed mat before the pressing step.

26. The method according to claim 22, wherein the release agent is added to the mixture prior to pre-pressing the mixture into a loose formed mat.

27. The method according to claim 22, wherein the release agent will not substantially interfere with subsequent processing of the composite.

28. The method according to claim 22, further comprising exposing at least one surface of at least one die to an anti-bonding agent.

29. The method according to claim 28, wherein the step of exposing the at least one surface of the at least one die to the anti-bonding agent comprises coating the at least one surface of the at least one die with the anti-bonding agent.

30. The method according to claim 22, wherein the isocyanate comprises diphenylmethane diisocyanate (MDI) or toluene diisocyanate (TDI).

31. The method according to claim 22 wherein the temperature used to press the mat into the thin layer composite comprises a range from about 250° F. (about 121° C.) to about 400° F. (about 204° C.).

32. The method according to claim 22, wherein the pressure used to press the mat into the thin layer composite comprises a range from about 2500 psi (about 176 kg/cm²) to about 150 psi (10.5 kg/cm²).

33. The method according to claim 22, wherein the predetermined resistance to moisture comprises a thickness swelling of less than 15% after being immersed for 24 hours in water at 70° F. (21° C.).

34. The method according to claim 22, wherein the acrylic polymer in the primer composition is present in an amount of from about 15% to about 35% by weight.

35. The method according to claim 22, wherein the acrylic polymer comprises an acrylic copolymer.

36. The method according to claim 22, wherein the acrylic polymer contains monomer units selected from the group consisting of be acrylic acid, butyl acrylate, 2-ethylhexyl acrylate, methyl acrylate, ethyl acrylate, acrylonitrile, methyl methacrylate, trimethylolpropane triacrylate, and combinations thereof.

37. The method according to claim 36, wherein the acrylic polymer further comprises monomer units selected from the group consisting of vinyl aromatics and combinations thereof.

38. The method according to claim 37, wherein the vinyl aromatic monomer groups are styrene.

39. The method according to claim 22, wherein the titanium dioxide is present in an amount of from about 0.5% to about 5% by weight.

40. The method according to claim 22, further comprising from about 1% to about 30% by weight thickening agents.

41. The method according to claim 40, wherein the thickening agents are selected from the group consisting of clay, aluminum silicate, clays, magnesium silicates, and combinations thereof.

42. The method according to claim 22, further comprising at least one additional component selected from the group consisting of surfactants, dispersants, organic solvents, fungicides, bactericides, catalysts, rheological agents, extenders, biocides, and combinations thereof.

43. The method according to claim 22, further comprising a pigment.

44. The method according to claim 43, wherein the composition comprises a pigment volume concentration load of from about 30% to about 40%.

45. A thin-layer lignocellulosic composite comprising a mixture of no more than about 99 wt % of at least one type of lignocellulosic fiber, wherein the fiber comprises a predetermined moisture content of at least about 4%, at least about 1 wt % of an organic isocyanate resin, a release agent, and a tackifier, wherein the mixture is substantially free of added wax and wherein the mixture is pressed between two dies at an elevated temperature and pressure and for a sufficient time forming a thin-layer composite of predetermined thickness, and allowing the isocyanate resin to interact with the lignocellulosic fiber such that the resultant thin-layer composite has a predetermined resistance to moisture, and wherein the thin-layer lignocellulosic composite is coated with a primer composition comprising:
(a) from about 10% to about 40% by weight of at least one thermoplastic acrylic polymer;
(b) from about 0.1% to about 20% by weight titanium dioxide; and
(c) water, wherein the primer composition has a basic pH, a solids ratio of from about 58% to about 69% by weight, and is substantially free of quartz pigments.

46. The thin-layer lignocellulosic composite according to claim 45, wherein the lignocellulosic fiber comprises wood.

47. The thin-layer lignocellulosic composite according to claim 45, wherein the mixture comprises from about 0.1% to about 5 wt % tackifier.

48. The thin-layer lignocellulosic composite according to claim 45, wherein the tackifier is selected from the group consisting of rosins, lignins, hydrogenated rosins, hydrocarbons, hydrogenated hydrocarbons, pure monomers, hydrogenated pure monomers, water-based dispersions, and combinations thereof.

49. The thin-layer lignocellulosic composite according to claim 45, wherein the release agent comprises an emulsion of surfactants and polymers.

50. The thin-layer lignocellulosic composite according to claim 49, wherein the mixture is preformed into a loose formed mat, and additional release agent is sprayed onto at least one surface of the mat prior to pressing the mat into the thin layer composite.

51. The thin-layer lignocellulosic composite according to claim 45, wherein the lignocellulosic fiber ranges from about 80% to about 98 wt % of the mixture.

52. The thin-layer lignocellulosic composite according to claim 51, wherein the predetermined moisture content of the fiber ranges from about 4% to about 15% moisture by weight after drying.

53. The thin-layer lignocellulosic composite according to claim 45, wherein the isocyanate comprises diphenylmethane diisocyanate or toluene diisocyanate.

54. The thin-layer lignocellulosic composite according to claim 45, wherein the predetermined thickness ranges from about 0.085 inches (about 2.16 mm) to about 0.250 inches (about 6.35 mm).

55. The thin-layer composite according to claim 45, wherein the acrylic polymer in the primer composition is present in an amount of from about 15% to about 35% by weight.

56. The thin-layer composite according to claim 45, wherein the acrylic polymer comprises an acrylic copolymer.

57. The thin-layer composite according to claim 45, wherein the acrylic polymer contains monomer units selected from the group consisting of be acrylic acid, butyl acrylate, 2-ethylhexyl acrylate, methyl acrylate, ethyl acrylate, acrylonitrile, methyl methacrylate, trimethylolpropane triacrylate, and combinations thereof.

58. The thin-layer composite according to claim 57, wherein the acrylic polymer further comprises monomer units selected from the group consisting of vinyl aromatics and combinations thereof.

59. The thin-layer composite according to claim 58, wherein the vinyl aromatic monomer groups are styrene.

60. The thin-layer composite according to claim 45, wherein the titanium dioxide is present in an amount of from about 0.5% to about 5% by weight.

61. The thin-layer composite according to claim 45, further comprising from about 1% to about 30% by weight thickening agents.

62. The thin-layer composite according to claim 61, wherein the thickening agents are selected from the group consisting of clay, aluminum silicate, clays, magnesium silicates, and combinations thereof.

63. The thin-layer composite according to claim 45, further comprising at least one additional component selected from the group consisting of surfactants, dispersants, organic solvents, fungicides, bactericides, catalysts, rheological agents, extenders, biocides, and combinations thereof.

64. The thin-layer composite according to claim 45, further comprising a pigment.

65. The composition according to claim 64, wherein the composition comprises a pigment volume concentration load of from about 30% to about 40%.
